(19) United States
(12) Patent Application Publication
(10) Pub. No.: US 2012/0046867 A1
(43) Pub. Date: Feb. 23, 2012

(54) Portable System for Analyzing and Determining Elemental Composition of Rock Samples

(76) Inventors: Daniel Faber, Kingston (AU); Susan Oda, Ottawa (CA); Adam Bell, Ottawa (CA); Thomas Ducellier, Ottawa (CA)

(21) Appl. No.: 13/213,952

(22) Filed: Aug. 19, 2011

Related U.S. Application Data
(60) Provisional application No. 61/375,417, filed on Aug. 20, 2010.

(51) Int. Cl. G06F 19/00; G01V 5/00

(52) U.S. Cl. 702/8; 250/255

(57) ABSTRACT

A portable system for elemental analysis includes one or more neutron emitters, a chamber for containing a test sample, at least one gamma ray detector electrically connected to a data acquisition system, and software or firmware executing on the data acquisition system from a non-transitory physical medium, the software or firmware providing a first function for producing one or more gamma ray spectrums, a second function for applying correction factors to the one or more gamma ray spectrums, and a third function for analyzing the corrected gamma ray spectrum or spectrums to determine a deconvolved elemental composition of the test sample.

### CROSS-REFERENCE TO RELATED DOCUMENTS

The present invention claims priority to U.S. provisional patent application Ser. No. 61/375,417, entitled “Non-destructive elemental analyzer and Method and Use Thereof” filed on Aug. 20, 2010, disclosure of which is incorporated herein at least by reference.

### BACKGROUND OF THE INVENTION

1. Field of the Invention

The invention is in the field of nuclear elemental analysis of core mine samples and relates to non-contact elemental analysis using Neutron Activation Analysis and related techniques. More particularly, the invention relates to a transportable system that utilizes Prompt Gamma Neutron Activation Analysis (PGNAA) and/or Delayed Gamma Neutron Activation (DGNA) to provide the base metal elemental composition of bulk rock samples.

2. Description of Related Art

Neutron capture or neutron activation analysis techniques are known in the art and have been subject to extensive research. A neutron source (nuclear reactor core, isotopic source or electrical neutron generator) is used to generate fast neutrons. Neutrons are then slowed down to thermal energy using moderating materials, and thermal neutrons then interact with the nuclei in a sample, which then emits characteristic gamma rays. The gamma rays are then detected and analyzed to determine the various elements present in the sample and their relative weights in order to provide an elemental analysis of the composition of the sample.

The PGNAA technique in particular, whereby the characteristic gamma-rays are given off quasi-instantaneously after neutron capture, has been used in the past to quantify the coarse elemental composition of coal and cement transported on a belt for example. The elemental composition information is then used as real-time feedback for process control. The main advantage of neutron-gamma related elemental analysis techniques is that both neutrons and gamma-rays have a large penetration depth in matter and therefore enable non-contact, non-destructive elemental analysis of bulk samples.

PGNAA is particularly attractive when the alternative involves taking a sub-sample of the material and sending it to an external laboratory for chemical and physical analysis. Such a process is lengthy, complex and expensive. There are also potential issues with sub-sampling, contamination, and incomplete chemical digestion that may affect the accuracy of traditional wet lab based analyses. DGNA may also be used in the same manner when the neutron interaction probability is high and the half-life of the resultant isotope is relatively short.

PGNAA, DGNA and related neutron analysis techniques known in the art have traditionally focused on major elemental composition. It is difficult to obtain sufficient accuracy for minor elements, especially for bulk samples that exhibit substantial gamma ray and neutron absorption (self-absorption), which would typically be the case for metal rich samples.

In base metal mining, the turnaround time for laboratory analysis of rock samples is typically four weeks, but during periods of high demand for commodities, it can be eight weeks or more. The delay in getting analysis results leads to inefficiencies in the drilling campaigns or mining operations being performed. Therefore it is desired that determining the compositions of both major and minor elements, with a focus on base metal content in rock core samples be performed more expeditiously.

Therefore, what is clearly needed in the art is a portable system that overcomes the problems of prior art analysis methods. Such a system would improve accuracy and trace detection capability utilizing characteristics for increased and/or lower sensitivity to sample gamma ray self-shielding, thermal neutron self-absorption, and composition in homogeneity.

### SUMMARY OF THE INVENTION

A problem stated above is that more accuracy and efficiency is desirable for elemental analysis of base rock samples collected during mining operations, but many of the conventional means for determining accurate elemental compositions such as, remote laboratory analysis also create delay, more expense, and more complexity. Moreover, sub-sampling, contamination, and incomplete chemical digestion may affect the accuracy of the final determination of the elemental composition.

The inventors therefore considered functional components of an elemental analyzing system, looking for elements that exhibit interoperability that could potentially be harnessed to provide non-contact elemental analysis, but in a manner that would not create delay, more expense, and more complexity.

Every mining operation is driven by how accurate its findings are relative to elemental analysis of rock samples and by how expediently those findings are revealed.

The present inventors realized in an innovative moment that if, at the point of sample taking, accurate elemental analysis could be performed, significant cost savings and avoidance of delay might result. The inventor therefore constructed a unique portable elemental analyzing system for analyzing rock samples that allowed fresh non-contaminated rock samples to be evaluated in the field in a safe manner without requiring expensive analysis utilizing remote facilities. A significant improvement in accuracy of results occurs, with no impediment to the efficiency of mining operations created.

Accordingly, in an embodiment of the present invention, a portable system for elemental analysis is provided including one or more neutron emitters, a chamber for containing a test sample, at least one gamma ray detector electrically connected to a data acquisition system, and software or firmware executing on the data acquisition system from a non-transitory physical medium, the software or firmware providing a first function for producing one or more gamma ray spectrums, a second function for applying correction factors to the one or more gamma ray spectrums, and a third function for analyzing the corrected gamma ray spectrum or spectrums to determine a deconvolved elemental composition of the test sample.

In one embodiment, the correction factors include one or a combination of a gamma ray self-shielding factor, a thermal neutron self-absorption factor, and a geometric correction factor. In one embodiment, the system further includes at least one moderator material for moderating emitted neutrons to thermal energy. In one embodiment, the system further includes a removable seed strategically positioned relative to the at least one gamma ray detector, the seed generating gamma rays, the gamma rays passing through the test sample. In a variation of this embodiment, the removable seed is made of mercury. In this embodiment, gamma-ray attenuation through the test sample is measured to compute a gamma-ray self-shielding correction factor. Also in this embodiment, the removable seed emits multiple Prompt Gamma Neutron Activation Analysis (PGNAA) peaks across a wide energy range exhibiting minimal overlap with PGNAA peaks emitted from the test sample in process. In a variation of this embodiment, the removable seed comprises more than one element.

In one embodiment, the system further includes a removable thermal neutron shield strategically positioned about the test sample, the shield having an opening positioned opposite the at least one gamma ray detector and wherein the shield surrounds a removable seed strategically positioned opposite the shield opening. In this embodiment, neutron attenuation through the sample is measured to compute a thermal neutron self-absorption correction factor. In a variation of this embodiment, the removable seed is formed of cadmium, mercury, samarium, gadolinium, or a combination thereof.

In one embodiment, there are two gamma ray spectrums produced, one a PGNAA spectrum and the other a Delayed Gamma Neutron Analysis (DGNA) spectrum, and wherein both spectrums are analyzed by the third software function. In this embodiment, a second gamma ray detector measures the DGNA gamma ray spectrum after repositioning the test sample.

According to another aspect of the present invention, in a system for elemental analysis, the system including one or more neutron emitters, a chamber for containing a test sample, and at least one gamma ray detector electrically connected to a data acquisition system, a method is provided for correcting a gamma ray spectrum to determine a deconvolved elemental composition. The method includes the steps (a) using software or firmware executing on the data acquisition system, determining the sample geometry and computing a geometric correction factor, the factor accounting for varying distances between nuclei in the test sample and the gamma-ray detector, (b) using the software of step (a), measuring a gamma ray spectrum, providing a first elemental composition for the sample, (c) using nuclear modeling software executing on the data acquisition system, computing the rate of neutron and gamma-ray absorption through a sample of the first elemental composition and sample geometry, (d) using the software or firmware of step (a), computing gamma-ray self-shielding and thermal neutron self absorption correction factors, (e) using the software or firmware of step (a), correcting the gamma-ray spectrum of step (b) according to results of steps (a), (c), and (d), (f) using the software or firmware of step (a), analyzing the corrected gamma-ray spectrum to obtain a second elemental composition, (g) using the software or firmware of step (a), calculating the difference between the second elemental composition of step (0, and the first elemental composition of step (b), comparing the difference to an established threshold value, and (h) assuming the difference calculated in step (g) is below the established threshold value, adopting the second elemental composition as the final deconvolved elemental composition.

In one aspect of the method, in step (b), the first elemental composition is substantially pure silica. In this aspect, in step (f), the second elemental composition is derived by analyzing the gamma-ray peaks present in the corrected gamma-ray spectrum and comparing the gamma-ray peak intensities to a library containing the theoretical peaks for all pure elements, with the balance of mass assumed to be pure Silica.

In one aspect of the method, the gamma ray spectrum is a PGNAA gamma ray spectrum, or a DGNA gamma ray spectrum. In this aspect, the system for elemental analysis produces a DGNA gamma ray spectrum and further includes a removable seed formed of Dysprosium, Europium, Indium, Lutetium, Manganese, or any combination thereof.

In a preferred aspect of the method, the data acquisition system is electrically connected to the gamma ray detector or detectors. In one aspect of the method, in step (h), if the difference is larger than the established threshold, steps (c) through (g) are repeated replacing the first elemental composition of step (b) with the second elemental composition of step (f).

### BRIEF DESCRIPTION OF THE DRAWING FIGURES

FIG. 1 is a perspective view of a PGNAA system according to an embodiment of the present invention.

FIG. 2 is a top view of a PGNAA system according to another embodiment of the present invention.

FIG. 3 is a top view of the PGNAA system of FIG. 2 according to another embodiment of the present invention.

FIG. 4 is a top view of the PGNAA system of FIG. 2 according to another embodiment of the present invention.

FIG. 5 is a process flow chart illustrating steps for correcting a raw PGNAA measurement according to an embodiment of the present invention.

FIG. 6 is a process flow chart illustrating steps for correcting a raw PGNAA measurement according to another embodiment of the present invention.

### DETAILED DESCRIPTION

The inventors provide a unique portable elemental analyzer that may be operated for determining elements from rock samples taken during mining operations. The elemental analyzer of the present invention employs either or both of the Prompt Gamma Neutron Activation Analysis (PGNAA) and Delayed Gamma Neutron Activation (DGNA) techniques to quantify the elemental composition of a test sample. The present invention will be described in enabling detail using the following examples, which may describe more than one relevant embodiment falling within the scope of the present invention.

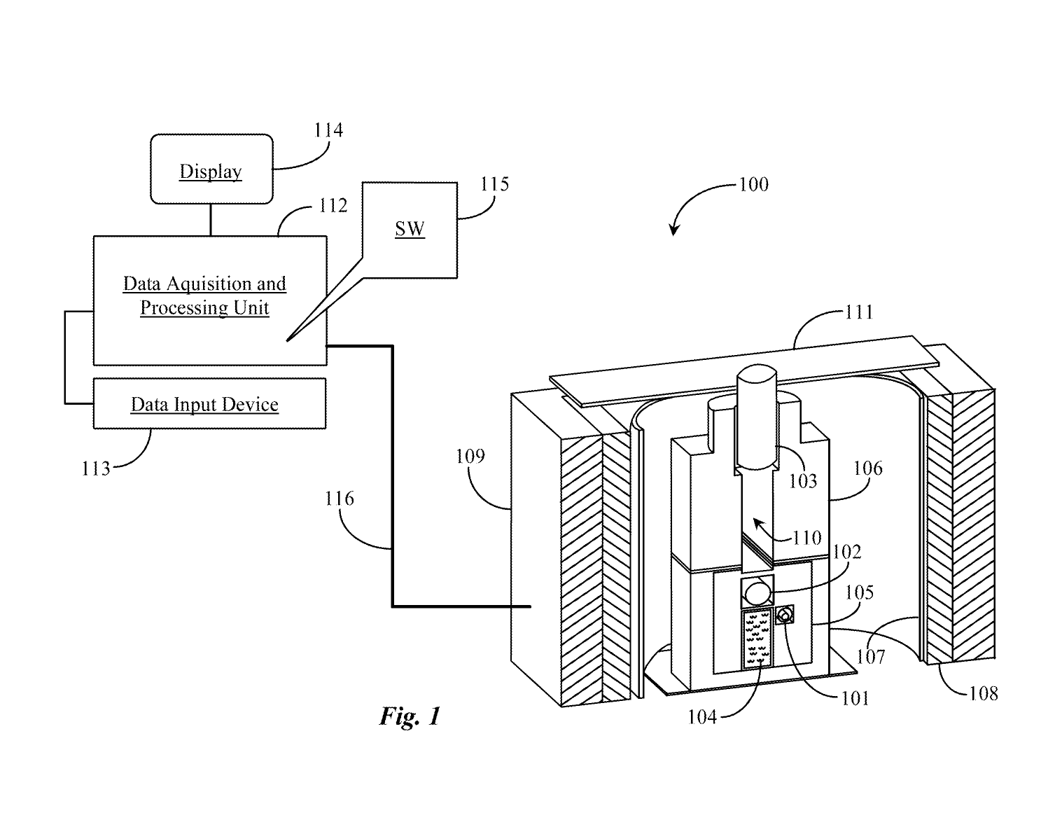

FIG. 1 is a perspective view of an elemental analyzing system 100 according to an embodiment of the present invention. Elemental analyzer system 100 includes a neutron source 101 that emits neutrons toward a target sample. Neutron source 101 may be an isotopic source, an electrical neutron generator, or any other source of neutrons presently known or yet to be developed without departing from the spirit and scope of the present invention.

In this example, neutron source 101 is an isotopic neutron source. Neutron source 101 is a spontaneous emitter of neutron radiation, either through direct radioactive decay, such as with a Californium source, or through indirect radioactive decay where a byproduct of the decay is utilized to induce a subsequent neutron emitting reaction such as for an americium-beryllium source, or an antimony-beryllium source, for example. Electrical neutron generators typically consist of a linear accelerator to accelerate deuterium or tritium ions towards a solid target implanted with either deuterium or tritium atoms. This technique is referred to herein as beam-on-target neutron generation. The energetic deuterium-deuterium or deuterium-tritium collisions cause some atoms to undergo fusion and emit neutrons at 2.45 MeV or 14.1 MeV respectively.

Other types of electrical neutron generators include spallation neutron sources, inertial electrostatic confinement fusion sources, or Van-der-Graph generator-based sources, as well as polywell types, which combine inertial confinement and a magnetic bottle. System 100 includes a sample chamber 102. Sample chamber 102 is adapted to receive test samples for elemental analyzing. In this embodiment, a test sample of material (i.e. rock sample) may be assumed present within chamber 102. Sample chamber 102 is cylindrical in this example, however other shapes may be utilized without departing from the spirit and scope of the invention.

In one embodiment, if the sample does not have mechanical integrity, it is advantageously put into a container for the purpose of assuming a predetermined shape of the container or mold within the container. For example, broken parts of a drill core can be put into a cylindrical sleeve container of the appropriate standard diameter corresponding to the diamond drill head diameter used while coring. Preferably the container is mounted vertically and rotated around a vertical axis of rotation to stop the material from shifting during rotation, with the gamma ray detector mounted horizontally. The container is advantageously made of a material that does not have a large PGNAA or DGNA cross-section and provides additional neutron thermalization, such as graphite or Teflon.

System 100 includes at least one gamma ray detection device 103. Gamma ray detection device 103 may be a scintillator crystal such as sodium iodide, or lanthanum bromide. The scintillator crystal may in turn be coupled to a photo-multiplier tube, or a solid block of high purity semiconductor such as germanium. In one embodiment both of the elements mentioned previously or a combination of both elements may be used as a gamma ray detection device when arranged to provide Compton suppression.

Advantageously, high purity germanium detectors provide a high level of spectral resolution, which enables greater discrimination of peaks emitted by various elements present in a test sample. It is noted herein that the present invention is not limited to a scintillator or semiconductor type of gamma ray detector. Other detectors capable of detecting and quantifying emitted gamma rays may be utilized without departing from the spirit and scope of the invention.

In one embodiment of the present invention, moderation materials are provided to slow down neutrons emitted by source 101 to thermal energy limits. Moderation material 104 is a liquid moderator and may consist of heavy water or plain water. Moderation material 105 is a solid moderator and may include sheets of polyethylene, graphite, wax, Teflon™ or some combination thereof, and may be enriched in duterium (ie. Depleted in hydrogen).

In general use moderation materials may be provided generally surrounding the neutron source in order to slow down neutrons from high energy (above 1 MeV) when they are generated, down to thermal energies (about 0.025 eV) where the probability of neutron capture remains the highest. Other moderator materials that might be utilized in accordance with the present invention include but are not limited to hydrogen, deuterium, beryllium, carbon, and lithium. Composite materials rich in such elements may also include water and heavy water.

In one embodiment of the present invention, conventional water is used as part of the moderation material. In this case, the water can be inserted after the equipment has been delivered in order to reduce the shipping weight of the instrument. In the case of liquid moderation material, the liquid can be pumped to various locations within the apparatus in order to induce predetermined changes in the thermal neutron spatial distribution, in particular enhancing neutron flux hitting the sample from predetermined locations at predetermined times and correlating the gamma ray detection to these predetermined times and locations to derive additional spatial information about the elemental composition of a sample.

In this example moderator materials 104 and 105 generally surround neutron source 101. However, moderation material 105 can be used in areas that are not in direct line-of-sight of gamma ray detector 103. This may be to maximize thermalization efficiency irrespective of its own PGNAA gamma ray emission. In one embodiment, hydrogen-rich material can be used like High-Density Poly Ethylene (HDPE). However, since hydrogen has a strong PGNAA peak at 2.2 MeV, it is advantageous to limit the amount of HDPE in direct line-of-sight of the detector in order to avoid flooding the detector with a strong 2.2 MeV peak. Moderation material not in direct line of sight of the detector (for example moderation material 104 in FIG. 1) can be heavy water or any other material chosen to have a small PGNAA cross-section and good moderation properties.

In one embodiment of the present invention, the test sample within camber 102 can provide some of the moderation, or all of the moderation, without the need for additional moderator material. Liquid samples are a good candidate for this embodiment. More generally, if the sample consists of a consistent and homogenous host material with embedded impurities, then inserting a neutron source and gamma ray detector inside the sample material can provide enough signal to measure the impurities with the sample providing most or all of the neutron thermalization. Advantageously, a predetermined amount of known material is inserted in the sample chamber to provide a proxy for in-situ measurement of the neutron field and enable additional correction factors to be derived.

Elemental analyzing system 100 includes various shielding materials for safety purposes. Shielding materials are provided to reduce gamma rays and neutrons emitted by the apparatus in order to protect operators of system 100. In this example, shielding materials include shielding materials 106, 107, 108 and 109. Shielding materials 106-109 may additionally serve to lower measurement noise floor by preventing background radiation (not emitted from the sample) from hitting gamma ray detector 103. This increases detector sensitivity for collimation of gamma rays. Shielding material is specifically selected to efficiently block X-rays, gamma rays, neutrons, and any other type of radiation produced inside system 100. For example, lead and boron can be used to shield gamma rays and neutrons emitted by system 100. Shielding materials 106-109 function to protect operators from potential harmful radiation and act to lower measurement noise floor as described further above.

Shield material 106 may be a lead-based shield. A void space 110 is provided directly in front of gamma ray detector 103. Shield 106 works in conjunction with void 110 to collimate gamma rays emitted by the sample within sample chamber 102 and to maximize signal-to-noise ratio. In this example, shield material 107 is a boron-based material. Shield 107 prevents potentially harmful neutrons from escaping system 100. Shield material 108 may comprise a high-density polyethylene (HDPE). Shield material 108 is disposed about the core of system 100 to further reduce fast neutron levels. Shield material 109, which may be lead or boron functions as a final human protection layer. Shield material 109 may also be structural steel or other material that forms the external casing of the system. It is noted herein that shielding materials 108 and 109 are not specifically required to practice the present invention. These shields are optional and their requirement is dependant at least in part on the strength of neutron source 101.

System 100 includes a data acquisition and processing unit 112 coupled to the gamma ray detector 103 via data cable 116. Unit 112 may be a computer system having an input device 113 and a display device 114 connected thereto for inputting commands, and data, and for displaying data and graphics respectively. In this example, a SW component 115 is provided for measuring gamma ray spectrums and for calculating correction factors for geometric configurations, thermal neutron self absorption, gamma ray self shielding, and other potential variables that may come into play during testing.

Data acquisition unit and processing unit 112 generally incorporate high-speed electronics and software. Units 112 picks up the electrical signals produced by the gamma ray detector(s) and analyzes gamma ray energy and count rate. Various methods are used to properly discriminate various events such as pulse pile-up rejection, coincidence detection, etc. Unit 112 derives a gamma ray spectrum representative of the PGNAA and/or DGNA interaction.

SW 115 includes functionality to carry out spectral analysis like peak searches (single or weighted average) or full spectrum analysis. These analyses are used to determine elemental content of a test sample from the gamma ray spectrum. Various correction factors based on the instrument set-up, sample geometry, and expected sample composition can be used in a deterministic or iterative convergence manner (driven by algorithms) to provide greater accuracy in the elemental composition determination.

In one embodiment of the present invention system 100 may include an automated loading mechanism (not illustrated) to feed the sample into the sample chamber. The loading mechanism can be used to improve safety, with a first sample entry chamber outside of shielding and an automated interlock protected mechanism to move the sample from the first sample entry chamber to the main sample test chamber within the radiation area with no human intervention. The loading mechanism can also be used to continuously feed in the sample to provide a composition average over length. This is particularly useful for long core samples.

In practice of the present invention, system 100 may be used as follows: A test sample, such as a drilled core from a base metal mine, is inserted into chamber 102. Neutron source 101 generates neutrons whose energy is optionally reduced (if the sample itself does not provide adequate moderation) by moderation materials 104 and 105 to increase the proportion of thermal neutrons. Thermal neutrons interact with test sample 102 causing the sample to emit gamma rays. Gamma ray detector 103 detects the gamma rays and data acquisition unit 112 (optimally including signal conditioning electronics and a multi-channel analyzer) generates a gamma ray spectrum.

The gamma spectrum is communicated to data processing unit 112 for data processing with aid of SW 115. Unit 112 uses the information contained in the spectrum to determine the elemental composition of the sample. Data processing steps may include the application of correction factors including a geometrical correction factor (GCF), a gamma ray self-shielding correction factor (SSCF), and/or a thermal neutron self-absorption correction factor (SACF). SACF also incorporates “fast neutron self-moderating” by the sample.

Where one or both of the gamma ray self-shielding correction factor, or thermal neutron self-absorption correction factor is unknown, convergence algorithms may be employed.

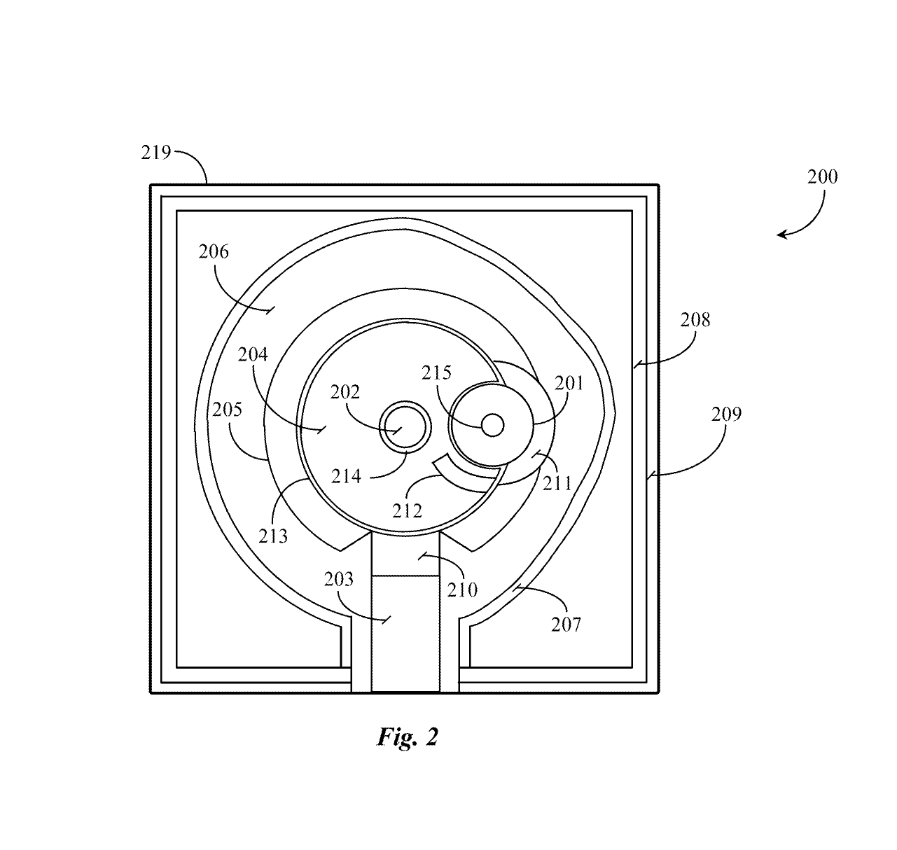

FIG. 2 is a top view of a PGNAA system 200 according to an embodiment of the present invention. In this example a neutron source 201 consists of a beam-on-target electrical neutron generator. In this embodiment, neutron generator 201 comprises a neutron-generating target labeled as target 215. In one embodiment, neutron generator 201 uses a deuterium-deuterium fusion reaction in order to enable easier licensing for transport and operation of the machine (as there is no radioactive material inside the apparatus).

It is important to note that neutron generator 201 and target 215 including the rest of the core 200 (materials contained within the external shielding of the system) are made of materials that are not the target elements to be measured during testing. To further illustrate, for an instrument focused at base metal detection, the amounts of copper, stainless steel, etc. is minimized to avoid interference with the test sample. Plastic, Teflon, aluminum, zirconium and materials with low PGNAA and DGNA cross-sections are preferred. Special consideration must also be paid to limiting the amount of potential activation of materials over time due to long-term exposure to a high neutron flux.

Neutron generator 201 is, in a preferred embodiment, controlled with a pulsed electrical generator (not illustrated) to enable pulses of neutrons to be emitted from target 215. In such an embodiment, electronics generic to gamma ray detector 203 can be synchronized with the pulsed neutron generator to infer additional information about the materials and the element distribution within the test sample. During a pulse, neutrons undergo thermalization over time, therefore the distribution of fast, epithermal and thermal neutrons is constantly varying over time in a predetermined manner. Since elements react differently to neutrons with different energy, a time-correlated detection of neutron interaction provides additional elemental information. Also the fast neutrons interact with the detector, thus by pulsing the NG there is an “off” period during which the background noise in the detector is lower.

Advantageously, predetermined amounts of materials with large neutron interaction cross-sections like rare earth elements for example, can be inserted in proximity to the sample in order to obtain in-situ information about the spectral distribution of neutrons under variant ranges of energy. In another embodiment, a neutron detector or a neutron spectrometer can be used to measure the spectral and spatial distribution of neutrons. Furthermore, the pulse neutron generator can further be configured with a predetermined electronic control pulse shape, anord pulse frequency and duty cycle, in order to shape the time distribution of thermal neutrons over time to render the thermal neutron flux in a substantially constant state over a given period of time during the pulsing cycle.

In this embodiment, moderation materials consist of a predetermined association of heavy water, deuterated and conventional polyethylene, graphite, Teflon, or other suitable moderation materials. In one embodiment, Monte Carlo multi-particle analysis (MCNP) SW or similar neutron transport modeling SW (may be incorporated into SW 115 of FIG. 1) is used to compute the thermal neutron flux and thermal neutron flux distribution within a sample and to optimize it to obtain the highest and most constant neutron flux distribution over the sample. Fast neutron blocker 212 is provided within system 200 and adapted to prevent fast neutrons from hitting the gamma ray detector 203 and causing damage.

Existing software options for modeling of neutron transport employing Monte Carlo methods include MCNP, MCNPX (Monte Carlo N-Particle Transport Code (eXtended), known to the inventors and developed and owned by Los Alamos National Laboratory. Another available SW is GEANT4 (Geometry and Tracking), developed by the Geant4 Collaboration http://cern.ch/geant4, which is freely available under the Geant4 Software License. Still another modeling SW is FLUKA (FLUktuierende Kaskade) sponsored and copyrighted by INFN and CERN. This program is also freely available under the FLUKA license. In one embodiment, new software (115) may be created that performs neutron transport only. The programs mentioned above model the transportation of neutrons, and may also model the transportation of photons, etc., in order to calculate the neutron and gamma ray flux distribution in a timely manner.

A gamma ray shield 206 made of lead surrounds the core of the equipment for human protection and to lower X-ray background. Advantageously, shield 206 can be made to assume the form of a collar shape around the top of detector 203 to provide gamma ray collimation and to protect the detector from being flooded by background gamma rays not emitted by sample 202 and to lower X-ray background noise. A borated sheet 207 is used to protect humans from neutrons escaping the core of the instrument and to prevent escaping neutrons from interacting with surrounding materials outside of the instrument. Additional protective layers 208 and 209 can be inserted for extra human safety, depending on the strength of the neutron source. All shielding may take the form of “multi layer” shielding whereby different materials are layered to minimize neutron, gamma-ray and x-ray flux as required.

In this embodiment, heavy water 204 surrounds a sample sleeve 214 containing a test sample 202. HDPE material 205 provides both moderation and reflection of neutrons towards sample 202. A fast neutron reflector 211 is provided to reflect neutrons back towards the system. Reflector 211 may be manufactured of beryllium, carbon or titanium. A heavy water container 213 is preferably manufactured of a neutron moderating material, like HDPE or Teflon. In one embodiment, a neutron multiplier material such as beryllium can be inserted in the moderation assembly to increase the neutron field. Non-hydrogenated material should be used in direct line of sight of the gamma ray detector in order to reduce noise induced by a strong Hydrogen 2.2 MeV PGNAA peak

In a preferred embodiment, heavy water 204 and/or void 210 is arranged in the moderator block in direct line of sight of the gamma ray detector. A cutout in HDPE moderator 205 can also be arranged in direct line-of-sight of the detector 203 to further reduce the strong Hydrogen gamma ray peak. In this last embodiment, HDPE is replaced with either heavy water or Deuterated Poly Ethylene (DPE), or any other suitable moderation material having a low PGNAA cross-section. In one embodiment, heavy water 204 or HDPE 205 may optionally be used as moderation materials by replacing either with conventional water.

Shielding materials are used both for human health protection (to prevent radiation from escaping from the instrument) and for enhanced detection sensitivity to prevent background radiation not emitted by the test sample from hitting detector 203. Shielding materials should be able to stop X-rays, gamma rays, and neutrons of various energy levels and any other type of radiation emitted by the machine or the test sample. In one embodiment, shielding and moderation materials are made to assume the shape of positively overlapping modular blocks.

In one embodiment, an additional layer of HDPE 208 can be used to slow down remaining fast neutrons, while a boron layer 209 can be used to stop all remaining slow neutrons. An external layer of lead 219 is optionally provided in this example. Layers 209 or 219 this layer may be e.g. structural steel. Layer 219 may be used to provide final X-ray and gamma ray shielding together with mechanical integrity. The exact details of various shield material compositions and configurations can be computed using nuclear modeling tools in order to ensure that the level of radiation escaping the apparatus complies with nuclear safety regulations of the countries where the equipment is being used. Many variant configurations are possible.

In one embodiment the sample is preferably rotated and/or translated to average the signal arriving at detector 203 from various positions within the sample. Advantageously, the sample rotation or translation is synchronized with the neutron generator pulse cycle to derive additional spatial information about the elemental composition in a sample. High purity semiconductor detectors are preferred for gamma ray detector 203 given the high level of spectral resolution required for elemental analysis. However, they have lower sensitivity as compared to crystal scintillators. Advantageously, a combination of both detector types can be used in tandem. This is especially the case in coincident detection systems that enable discrimination between Compton events, electron-positron pair production, and actual photo peak signal. This may also be the case when varying detection levels or sensitivities are required while conducting the calibration steps described further below, which can be carried out quickly and inexpensively using a scintillator detector.

It is noted herein that gamma rays emitted within the sample volume are always attenuated by the sample itself. This is especially true for large samples (such as 1 kg) containing metals. This process is known as gamma ray self-shielding. This effect is particularly strong for low energy gamma rays, while high energy gamma rays travel through matter with a lower attenuation. There is also a higher background noise floor at lower energy due to Compton scattering events in the moderation and shielding materials and in the detector itself. Therefore the detector should be tuned to maximize the detection of high-energy gamma rays. A filter (not illustrated) may optionally be placed on top of the detector to help selectively attenuate low energy gamma rays before they reach the detector and reduce “pulse pileup” effects.

Filtering allows most of the high-energy gamma rays to travel to the detector. Such a filter may be made with a first thin sheet of a first material like lead to stop low energy gamma rays followed by a sheet of second material like tin or copper to stop X-rays emitted while the first material interacts with the low energy gamma rays.

Data acquisition electronics such as data acquisition system 112 aided by SW 115 are used to acquire the electrical signal from gamma-ray detector 203 and compute a gamma-ray spectrum. Gamma ray interactions with detector(s) 203 generate pulses that are tallied according to pulse height. Pulse height is proportional to the gamma ray energy. When two or more gamma rays interact with detector 203 within the processing time of the readout electronics (a situation referred to as “pile-up”) it can be difficult to differentiate the individual pulse heights. These pulses may be rejected by the processing electronics. Alternatively a “pulse fitting” algorithm may be applied that provides improved accuracy over simple “pulse height” detection. Pulse fitting is able to better resolve pulses that occur close in time, thus improving immunity to pulse pile-up.

Progress in the speed of computing enables an all-digital signal acquisition system for both semiconductor and scintillator gamma ray detectors. Therefore, digital pulse fitting of gamma ray events is preferred as opposed to conventional analog signal conditioning. This enables deconvolution of piled-up events as opposed to simply rejecting them. Pure digital pulse fitting increases the maximum net count rate and therefore the overall system sensitivity. Digital pulse fitting can also reduce spectrum broadening due to ballistic deficit, which is particularly important in large (high efficiency) gamma ray detectors. Ballistic deficit is caused by errors in calculation of the pulse height due to variations in the rise-time of the gamma-induced signal pulse that results from the physical mechanisms of charge collection in a semiconductor detector. Other advantages of digital pulse fitting include higher throughput, better stability, and the ability to adjust signal filter parameters over a wide range to optimize performance.

Once the signal has been acquired and analyzed by a data acquisition system such as system 112 of FIG. 1, a gamma ray spectrum is produced. Simple peak extraction can be used to identify elements present in the sample, but this does not build upon all the information contained in the spectrum. It is preferred that a full spectrum analysis is performed that looks for correlation between peaks and analyzes the background level for Compton-plateaus characteristic of certain elements. In one example, assume that a peak created by elements present in the instrument is masking a peak resulting from an element present in the sample. This may occur when a boron peak is adjacent to a nickel peak where the boron sources from the instrument shield and the nickel sources from the sample under test. Looking at the background level may provide, in this case, additional inferred information for the masked peak by taking into account all other known elements contained in the test sample.

The data acquisition system applies correction factors to the measured gamma ray spectrum in order to achieve suitable accuracy given variable sample geometry, sample inhomogeneity, gamma ray self-shielding, and thermal neutron self-absorption. The geometry of the system is also taken into account for correction factoring. These correction factors may be calculated theoretically using MCNP or similar equivalent neutron transport modeling software, which may be incorporated into SW 115 without departing from the spirit and scope of the present invention. Extra calibration measurements provide the appropriate measured correction factors where the composition of the sample is partially or completely unknown.

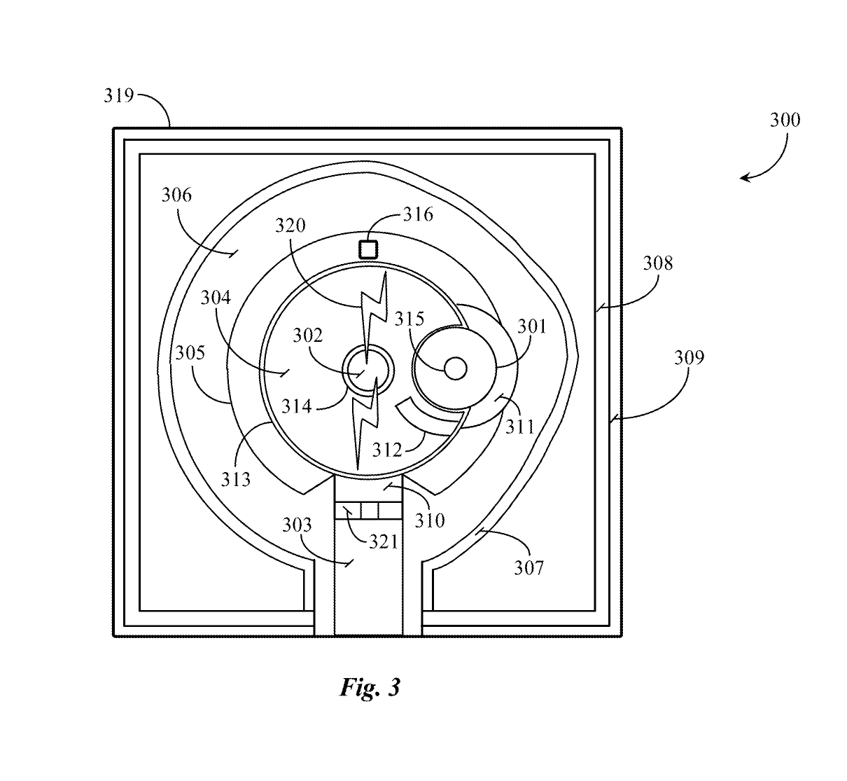

FIG. 3 is a top view of a PGNAA system according to another embodiment of the present invention. It is noted herein that many of the same elements are shared by both the systems of FIG. 2 and FIG. 3. Element numbers beginning at 300 are used to describe these counterpart elements and they are not reintroduced unless they differ in function from the previous elements described with respect to FIG. 2.

In this example, a removable seed 316 is added according to one embodiment of the present invention. Seed 316 is of a predetermined composition and is added to the system in order to generate known amounts of characteristic gamma rays 320. The seed may be a radioactive seed or a PGNAA seed such as Cobalt-60. Gamma rays 320 are attenuated according to the sample gamma ray attenuation characteristics as they pass through sample 302. This process can be used to compute the sample gamma ray attenuation coefficient per unit length when the sample and set-up geometry are known with sufficient precision. In an alternative embodiment, gamma rays 320 can be collimated in front of gamma ray detector 303 by an optional collimator 321. Collimator 321 may be made of lead or other strong gamma ray absorbing material. Collimator 321 includes an aperture defining a line-of-sight passage for gamma rays 320. A straight, non-divergent path from the aperture of collimator 321 to seed 316 defines a precise section of the sample through which the gamma rays 320 pass. The length of this section of sample can be measured accurately enabling a direct measurement of the gamma ray attenuation coefficient per unit length.

The sample gamma ray attenuation coefficient per unit length per the above example is used in subsequent gamma ray self-shielding and neutron flux spatial and energy distribution correction steps as described later in this specification. Seed 316 preferably comprises a material that has a large PGNAA cross-section to enable a fast measurement. The seed material should not be present in a large concentration in sample 302. Seed 316 should have multiple PGNAA peaks across a wide energy range in order to provide a gamma ray correction factor as a function of gamma ray energy. One material that would be suitable for seed 316 is mercury. Alternatively the seed may emit gamma rays due to radioactive decay rather than PGNAA, for example in this case the seed may be Cobalt 60 or Europium.

In a preferred embodiment, seed 316 is mounted on a linear actuator (not illustrated) to allow the sample to be scanned in its longitudinal direction in order to obtain spatial information about the sample gamma ray self-shielding. Alternatively, or in conjunction with the scanning of the seed 316, sample 302 can also be rotated and/or translated to obtain a geometrical average of its gamma ray self-shielding factor. Seed 316 is removable so as to not interfere with the PGNAA measurement of sample 302.

Seed 316 may have the shape of a small point element with overall dimensions at least ten times smaller than that of the sample. It may consist of a small line element or a sheet. It is noted herein that multiple known elements may be used for seed 316. Each different element will have a separate set of characteristic gamma rays for acquisition of gamma ray attenuation information as a function of gamma ray energy. Either the seed elements are used in sequence or collectively to save calibration time if more than one variant seed is used.

In one embodiment, using a high efficiency scintillator detector (303) to detect the gamma rays emitted by the known element(s) in seed 316 during calibration steps further reduces calibration time. Reduction in calibration time is aided by the strong signals given off by the known seed element or composition. In this embodiment detector 303 consists of two gamma ray detectors. One is a scintillator used for the calibration steps and the other a high precision semiconductor detector for the sample PGNAA measurement.

Alternatively, to increase sample throughput, a seperate sample chamber is used for some or all of the calibration steps, either utilizing neutrons from a single neutron source or using a separate neutron source or using purely radiactive decay elements as gamma ray sources.

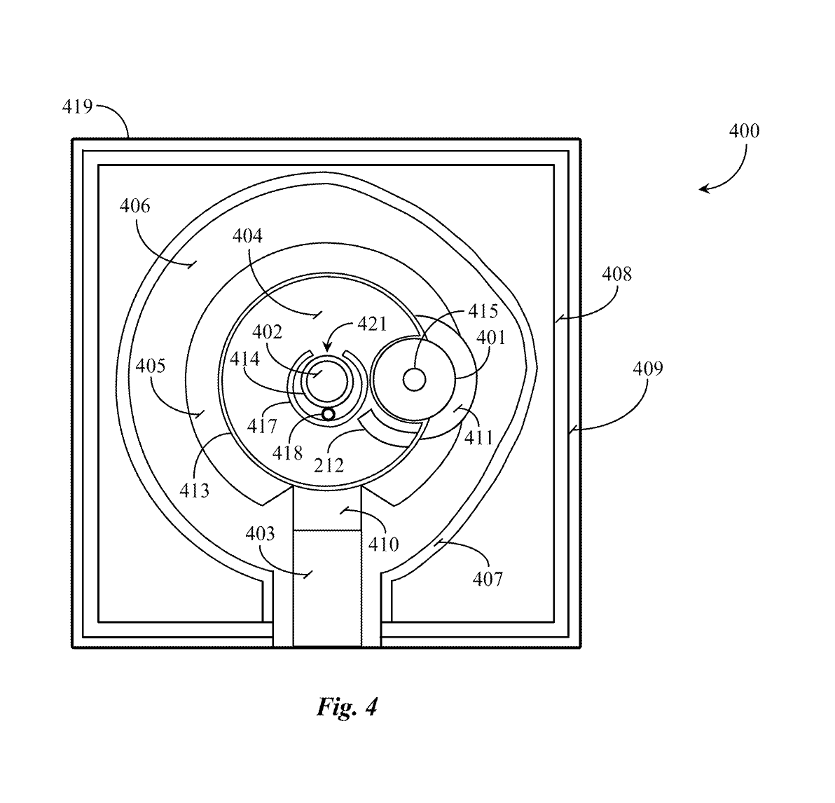

FIG. 4 is a top view of a PGNAA system 400 similar to system 200 of FIG. 2 according to another embodiment of the present invention. It is noted herein that many of the same elements are shared by both the systems of FIG. 2 and FIG. 4. Element numbers beginning at 400 shall be used to describe these counterpart elements and they are not reintroduced unless they differ in function from the previous elements described with respect to FIG. 2.

In this example, a removable thermal neutron shield 417 is provided. Thermal neutron shield 417 surrounds sample 402 leaving a small void 421 in the shield. Thermal neutron shield 417 is adapted to absorb substantially all neutrons coming from all directions except that of void 421. A removable PGNAA seed 418 is inserted proximate to sample 402 and opposite opening 421. A seed 418 is provided within shield 417 and opposite sample 402 and shield opening 421. Seed 418 is selected for characteristically large PGNAA cross-section while, at the same time, being unlikely to be present in large quantity in sample 402. Seed 418 may be made of cadmium, mercury, gadolinium, or samarium. Thermal neutron shield 417 may also be made of any of cadmium, gadolinium, or samarium, but seed 418 and shield 417 must be made of different materials.

In use, only thermal neutrons coming through opening 421 can enter the space defined by thermal neutron shield 417. Those thermal neutrons pass through sample 402 and interact with seed 418. Thus, a PGNAA measurement of gamma ray peaks characteristic of seed material 418 may provide a direct measurement of thermal neutron attenuation through sample 402. This result can be used to improve upon deconvolution algorithms described later in this specification that correct for thermal neutron self-absorption as measured compared to calculated values computed by MCNP or similar neutron transport modeling SW.

In a preferred embodiment, seed 418 is mounted on a linear actuator (not shown) to scan the sample in its longitudinal direction in order to obtain spatial information about the sample thermal neutron self-absorption. Alternatively, or in conjunction with the scanning of seed 418, sample 402 can also be rotated and/or translated to obtain a geometrical average of its thermal neutron self-absorption factor. Shield 417 and seed 418 are removable so as not to interfere with the PGNAA measurement of sample 402.

Fast neutrons, which may not be so readily absorbed by the shield, will also enter the space defined by neutron shield 417. By similar techniques to those described for thermal neutrons above, a direct measurement of neutron thermalization through sample 402 can be obtained. In the preferred embodiment described, the measurement of neutron thermalization is performed at the same time as the measurement of thermal neutron attenuation, and the signals and the measurements are not separable. Alternatively the measurement of neutron thermalization can be separated from the measurement of thermal neutron attenuation by removing the opening 421 such that neutron shield 417 completely surrounds the sample.

Seed 418 can have the shape of a small point element having overall dimensioning at least ten times smaller than that of the sample. Seed 418 may be a small line element or a sheet. A high efficiency scintillator detector may be used to detect gamma rays during calibration given the strong signal produced by seed 418 to decrease calibration time. Alternatively, seed 418 may be a removable seed of a material with a high DGNA cross-section. The neutron flux in the vicinity of the sample can be determined by measuring the DGNA activity of the seed. The activity of the DGNA seed (418) may be measured in situ when the neutron generator 401 is powered off or it may be measured upon removal when placed in proximity to a gamma ray detector. The DGNA detector in this case may be a spectrometer or it may be a gamma ray counter. Alternatively, to increase sample throughput, a separate sample chamber is used.

One with skill in the art of nuclear sampling of materials will concur that the processes described above with respect to the examples of FIG. 3 and FIG. 4 may be used in isolation from, in conjunction with, or in parallel with one another. The calibration measurements can be done in sequence or simultaneously. In one embodiment, if the composition of the sample is approximately known, a direct calculation of average gamma ray self-shielding and thermal neutron self-absorption correction factors may be made. Such a case would assume, for example, an ore grading environment for an operating mine. In such cases, the average rock composition does not change substantially and the grade for the element of interest varies in small proportions. Another case in point is when the gamma ray self-shielding and thermal neutron self-absorption variations are low enough to not impact the accuracy of the PGNAA measurement substantially. If the composition of the sample is either partially known or unknown, the calibration processes described above are used. However, a convergence algorithm may be required to determine the correction factors when the sample composition is not known with enough precision to enable accurate correction factors to be determined beforehand, or when one or more of the calibration processes described further above is not available or omitted.

It is noted herein that for the convergence algorithms discussed below, it is assumed that the sample geometry is known or can be measured with a fine accuracy, or that the sample is made to assume a predetermined known shape. Based on known geometry, a r² geometric correction factor can be computed to account for the varying distance between nuclei in the sample and the gamma ray detector. It is also assumed that the sample is homogeneous. If the sample is not homogeneous, then a rotating and translating sample holder may be provided and used to provide average measurements over time, providing an approximation of what the result might have been for a stationary measurement of a homogeneous sample.

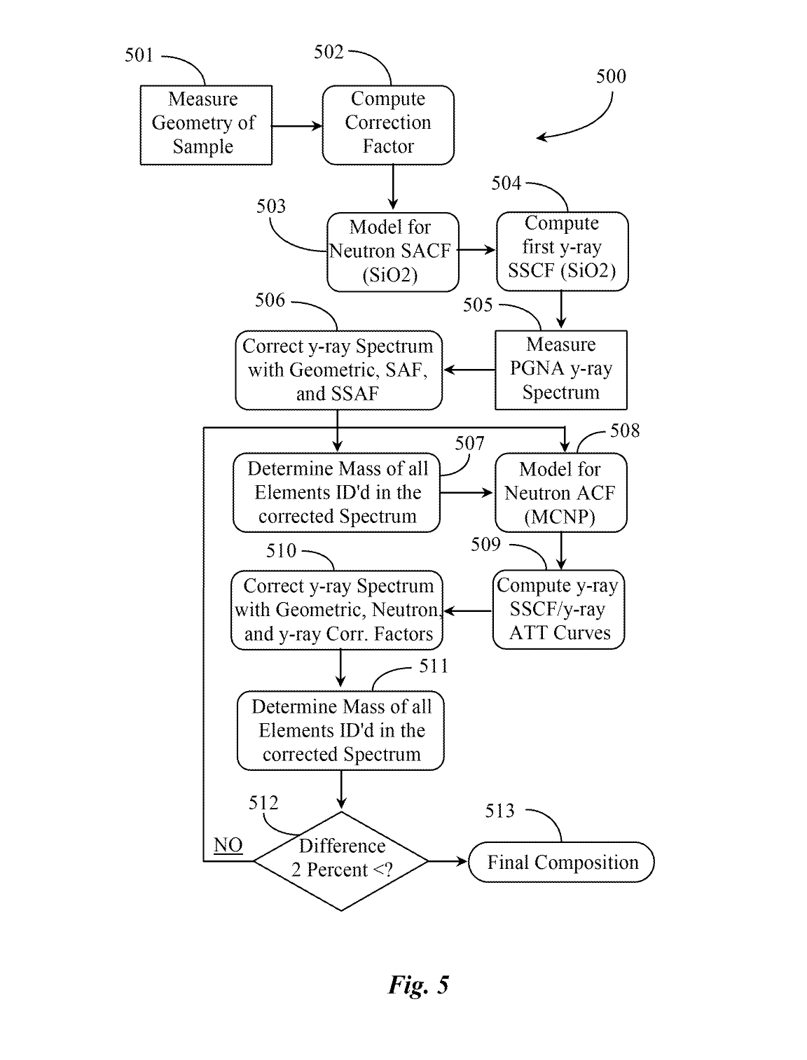

FIG. 5 is a process flow chart 500 illustrating steps for correcting a raw PGNAA measurement according to an embodiment of the present invention. At step 501, the sample geometry is accurately measured in order to compute an r² geometric correction factor. At step 502, an r² correction factor is computed. At step 503, a first thermal neutron self-absorption correction factor (SACF) is computed using MCNP or similar neutron transport modeling SW. This process assumes that the sample is made of pure silica with a shape determined in step 501.

At step 504, a first gamma ray self-shielding correction factor (SSCF) is computed assuming that the sample is made of pure silica with a shape as calculated as a geometric correction factor in step 501. At step 505, the computed PGNAA gamma ray spectrum is measured. At step 506, the measured gamma ray spectrum is corrected using the geometric correction factor computed at step 502, the first neutron correction factor computed at step 503, and the first gamma ray self-shielding correction factor computed at step 504.

At step 507, a first composition guess is determined based on the strength of all identifiable peaks in the corrected gamma ray spectrum as compared to reference measurements in libraries obtained with pure elements measured with the system. The balance of mass is assumed to be silica (SiO2). Using this first composition guess, a MCNP or similar neutron transport model is created at step 508 to compute the neutron flux going through the sample. This neutron flux is used to calculate a correction factor accounting for thermal neutron self-absorption through the sample Neutron thermalization may also be calculated and incorporated into the thermal neutron flux.

At step 509, the composition guess is used to compute a gamma ray self-shielding correction factor (SSCF) based on theoretical gamma ray absorption for each element in the composition determination.

At step 510, the measured PGNAA gamma ray spectrum is corrected using the geometric correction factor computed at step 502, the thermal neutron self-absorption correction factor computed at step 508, and the gamma ray self-shielding correction factor determined at step 509. This new corrected gamma ray spectrum is used to determine a new composition guess at step 511. This new composition determination is compared at step 512 with the previous composition determination of step 507. If at step 512, the difference between the first and second determinations is less than 2% (a sufficiently small error), then at step 513 the last composition determination is deemed to be the final composition of the sample at step 513. If at step 512, the difference is larger than 2%, then the process resolves back to step 508 and runs again until convergence is achieved below the established threshold value. If the process does not converge within a predetermined maximum number of steps, an error signal may be produced.

The final accuracy used in step 512 depends on the target accuracy required in the measurement, and taking into account the maximum accuracy that can be achieved given the limitations of the experimental set-up (especially as it relates to counting statistics limitations) and is also determined as a compromise between accuracy and computing time since MCNP or similar neutron transport models as used in step 503 and 508 are computationally intensive.

An alternative to using full MCNP or similar neutron transport models is to use a set of pre-calculated values each representing the neutron flux in the sample volume as attenuated due to thermal neutron self-absorption caused by a single pure element and combining these absorption factors according to the composition guess obtained at steps 507 or 511. This leads to a small error (approximately 10%), which can be acceptable for a first quick convergence analysis algorithm.

It is noted here that SiO2 used as the first composition at step 503 or as composition balance in steps 507 and 511 can be replaced with more complex formulations if the host rock matrix is known or approximately known including, without limitations, carbonates, silicates, halides, phosphates, sulphides, and oxides. This enables better convergence and higher accuracy. To further improve both accuracy and convergence, or if no convergence can be obtained with the method described above, additional calibration factors need to be measured like in-situ gamma ray self-shielding followed by an iterative convergence algorithm described further below, or in-situ gamma ray self-shielding and thermal neutron self-absorption (measurements described in FIG. 3 and FIG. 4) followed by a deterministic calculation of appropriate correction factors.

The following table illustrates the results of the process of FIG. 5.

| | Copper @ 278 keV | | | Nickel @ 8998 keV | | | Iron @ 352 keV | | | Sulphur @ 2379 keV | | |
|---|---|---|---|---|---|---|---|---|---|---|---|---|
| | Corr | Corr | | Corr | Corr | | Corr | Corr | | Corr | Corr | |
| | Factor | Peak | Mass | Factor | Peak | Mass | Factor | Peak | Mass | Factor | Peak | Mass |
| Round | 2.437 | 2 86978412 | 134.3317 | 1.06 | 0.0177659 | 19.71377386 | 2.199 | 1.3431736 | 143.4509 | 1.241 | 0.2016487 | 154.4629127 |
| 1 | | | | | | | | | | | | |
| Round | 3.434 | 4 04384024 | 189.2881 | 1.488 | 0.0249392 | 27.673675 | 3.002 | 1.833655 | 195.8343 | 1.686 | 0.2739563 | 209.8505003 |
| 2 | | | | | | | | | | | | |
| Round | 3.864 | 4 55020347 | 212.9905 | 1.672 | 0.0280231 | 31.09568857 | 3.337 | 2.0382767 | 217.6879 | 1.87 | 0.3038542 | 232.7523342 |
| 3 | | | | | | | | | | | | |
| Round | 4.027 | 4 74215046 | 221.9754 | 1.742 | 0.0291963 | 32.39754156 | 3.46 | 2.1134064 | 225.7118 | 1.938 | 0.3149035 | 241.2160555 |
| 4 | | | | | | | | | | | | |
| Round | 4.098 | 4 82575927 | 225.889 | 1.772 | 0.0296991 | 32.95547856 | 3.513 | 2.1457794 | 229.1692 | 1.967 | 0.3196156 | 244.8255836 |
| 5 | | | | | | | | | | | | |

The table illustrates the result of the convergence of the algorithm represented by process flow chart 500 in an empirical analysis. A sample of massive sulphide rock containing Cu, Ni, Fe, S, and other elements was analyzed with a focus on base metals. Using the algorithm described above, a calculated composition is determined after 5 convergence steps.

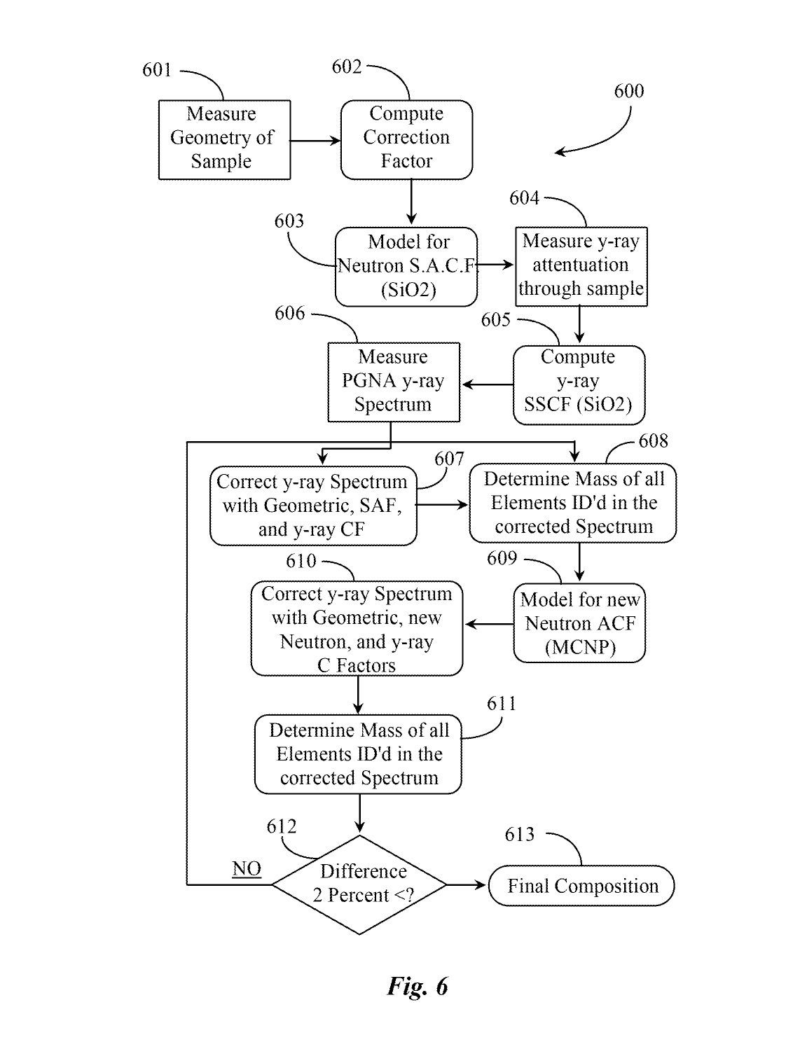

FIG. 6 is a process flow chart 600 illustrating steps for correcting a raw PGNAA measurement according to another embodiment of the present invention. Process flow chart 600 illustrates a more accurate process representing a deconvolution algorithm based on measured gamma ray self-shielding when only thermal neutron self-absorption is unknown.

At step 601, the sample geometry is determined with enough accuracy to enable an r² geometric compensation factor to be computed. At step 602, the geometric correction factor of the sample is computed based on the measurements of step 601. At step 603, the sample composition is first assumed to be pure Silica and an MCNP (or similar neutron transport model) calculation is performed to compute the thermal neutron self-absorption in the sample and derive a thermal neutron self-absorption correction factor. A measure of gamma ray attenuation is performed at step 604 using for example the configuration described in FIG. 3 above. This gamma ray attenuation measurement is used to compute an actual gamma ray self-shielding correction factor at step 605.

At step 606, the PGNAA gamma ray spectrum of the sample is measured. At step 607, the measured gamma ray spectrum is corrected using the gamma ray self-shielding correction factor computed at step 605, the thermal neutron self-absorption correction factor computed at step 603, and the r² geometric compensation factor computed at step 602. At step 608, the corrected gamma ray spectrum is analyzed to provide a first composition guess by comparing the peaks measured with a library of PGNAA gamma ray responses for pure elements. The composition balance is assumed to be Silica in this example. At step 609, the guessed composition of the sample is used to construct an MCNP or similar neutron transport model and to calculate a thermal neutron self-absorption correction factor.

At step 610, the measured gamma ray spectrum is corrected using the geometric correction factor computed at step 602, the gamma ray self-shielding correction factor determined at step 605, and the thermal neutron self absorption correction factor computed at step 609. This new corrected gamma ray spectrum is then analyzed to determine a new composition guess at step 611. At step 612, this new guess is compared to the previous values to assess convergence. At step 612, if the difference is below the predetermined convergence threshold (for example, less than 2% composition change), then the last composition guess is outputted by the instrument at step 613 as the final composition. If the difference is above the convergence threshold at step 612, then the process resolves back to step 609 and resumes until the convergence is achieved.

If the algorithm does not converge in a predetermined maximum number of iterations, an error message is given indicating a need to either use a better start composition guess. This may be achieved, for example, by changing silica as the first composition at step 603 and as composition balance at steps 608 and 611 to a composition more representative of the rock forming elements expected to be present in the sample. Alternatively, the system may perform an in-situ thermal neutron self-absorption calibration measurement as described further above in FIG. 4.

The convergence threshold used in step 612 depends on the target accuracy required in the measurement, given the maximum accuracy that can be achieved due to the limitations of the experimental set-up (especially as it relates to signal to noise error and counting statistics limitations) and is also determined as a compromise between accuracy and computing time, since MCNP or similar neutron transport models as used in steps 603 and 609 are computationally intensive. In this algorithm, it is also possible to replace actual MCNP or similar neutron transport modeling steps 603 and 609 with a quicker computation using a set of pre-calculated values each representing the neutron flux due to thermal neutron self-absorption caused by a single pure element and combining these absorption factors according to the composition guess obtained at steps 608 or 611. This results in an error of approximately 10% on the final accuracy. Therefore, it can be used to make a first quick analysis, or in cases where a coarse accuracy is sufficient.

The table below illustrates the result of the process of FIG. 6.

| | Copper @ 278 keV | | | Nickel @ 8998 keV | | | Iron @ 352 keV | | | Sulphur @ 2379 keV | | |
|---|---|---|---|---|---|---|---|---|---|---|---|---|
| | Corr | Corr | | Corr | Corr | | Corr | Corr | | Corr | Corr | |
| | Factor | Peak | Mass | Factor | Peak | Mass | Factor | Peak | Mass | Factor | Peak | Mass |
| Round | 2.5489 | 3.00155632 | 140.4959 | 1.0989 | 0.0184178 | 20.43723216 | 2.1916 | 1.3385536 | 142.9682 | 1.2273 | 0.1994226 | 152.7577218 |
| 1 | | | | | | | | | | | | |
| Round | 3.466 | 4.08152309 | 191.052 | 1.506 | 0.0252409 | 28.00843719 | 2.984 | 1.8226604 | 194.6601 | 1.68 | 0.2729813 | 209.1037013 |
| 2 | | | | | | | | | | | | |
| Round | 3.804 | 4.47954813 | 209.6832 | 1.655 | 0.0277382 | 30.77952427 | 3.276 | 2.0010172 | 213.7086 | 1.846 | 0.2999545 | 229.7651385 |
| 3 | | | | | | | | | | | | |
| Round | 3.929 | 4.62674674 | 216.5734 | 1.712 | 0.0286935 | 31.83960457 | 3.386 | 2.0675956 | 220.8192 | 1.909 | 0.3101913 | 237.6085273 |
| 4 | | | | | | | | | | | | |
| Round | 3.973 | 4.67856056 | 218.9988 | 1.732 | 0.0290287 | 32.21156256 | 3.423 | 2.0908064 | 223.2981 | 1.932 | 0.3139265 | 240.4692565 |
| 5 | | | | | | | | | | | | |

The table illustrates the result of the convergence of the algorithm represented by process flow chart 600 in an empirical analysis. A sample of massive sulphide rock containing Cu, Ni, Fe, S, and other elements was analyzed with a focus on base metals. Using the algorithm described above, a calculated composition is determined after 5 convergence steps.

In the processes of FIG. 5 and of FIG. 6 above, correction factors are determined to correct a measured PGNAA gamma ray spectrum to account for r² geometric effects, thermal neutron self-absorption in the sample and gamma ray self-shielding in the sample. The correction factors can be represented as a single number, a set of numbers (especially as a set of numbers depending on the gamma ray energy in the spectrum), a continuous function or functions, or represented in a matrix form (2D, 3D, or otherwise), depending on the mathematical model used. The gamma ray spectrum can be represented by a set of numbers, a function or functions, or an abstracted version of the measured data, for example a list of peaks and associated peak areas and energies.

Relevant to correction factors, each correction factor is first computed in a three-dimensional matrix form before being combined and applied peak-by-peak to the list of peaks representing the measured gamma ray spectrum, however multiple other mathematical representations are possible to implement the algorithms represented above. More particularly, the correction factors due to r², neutron self-absorption, and gamma attenuation are each represented as three-dimensional arrays of correction coefficients calculated at locations within the sample represented by uniform sized cells in a corresponding three-dimensional grid of a given arbitrary spatial resolution. Where a correction coefficient is normalized to a reference sample, the reference sample is chosen to have negligible neutron interactions for absorption or scattering, such as air or vacuum. For example a preferable Monte Carlo neutron transport model will have a reference sample composition of vacuum and a reference cell location in the center of the sample chamber.

In actual practice, the correction factors are multiplied element-by-element then averaged over the sample volume in order to obtain a combined correction factor, as per the following equation:

$${f}_{e} = \frac{1}{n} {\sum }_{cell = i} [ {η}_{Φ ti} {η}_{γ et} {η}_{r} {z}_{i} ]$$

### Where:

fₑ is the dimensionless combined correction factor, at a gamma-ray energy e corresponding to a peak of interest in the gamma spectrum.
n is the total number of cells in the grid
η_{Φτi} is the thermal neutron self-absorption correction factor, being reciprocal of the thermal equivalent neutron flux, Φ_{τ}, in cell i, normalized to the flux of the reference cell for the reference sample, Φ_{τr}, giving:

$${η}_{Φ t} = \frac{{Φ}_{tr}}{{Φ}_{t}}$$

The neutron absorption cross-section varies with neutron energy and it is necessary to express the neutron flux as a “thermal equivalent neutron flux”. The neutron absorption cross-section of most elements is proportional to the reciprocal of velocity (and therefore proportional to the reciprocal of energy squared) up to energy of 1 eV. This can be normalized to the mean thermal energy of 0.0252 eV, as follows:

$${Φ}_{t} = {\sum }_{i = 0}^{{e}_{i} = 1 eV} \frac{{( 0.0252 )}^{2} {Φ}_{i}}{{e}_{i}^{2}}$$

Where Φᵢ is the neutron flux tally in energy bin i, at energy eᵢ, derived from the neutron transport model. For elements that have neutron absorption cross-sections divergent from the “reciprocal of velocity” relationship a correction such as the Wescott-g factor can be applied, for example as explained in “Handbook of Prompt Gamma Activation Analysis”, G. Molnar, Chapter 1. η_{yet} is the reciprocal of the gamma transmission fraction from cell i to the detector, of gamma rays of energy e (equal to one minus the gamma self-absorption). It can be calculated from a known or estimated composition by the exponential of the sum of the attenuation coefficients of each element in the sample:

$${η}_{γ e} = \frac{exp [ {\sum }_{e} ( {\int }_{R} {μ}_{e} {ρ}_{e} d R ) ]}{{η}_{γ ec}}$$

Where μₑ is the gamma mass attenuation coefficient in cm²·grams⁻¹, ρₑ is the element density in grams·cm⁻³, and R is the distance from the cell to the detector in centimeters. The attenuation coefficient should be calculated as an integral over the distance R due to variations in material composition and thickness, including changes in materials (e.g. filters) between the sample and the detector and changes in the sample itself. In the example shown in FIG. 5B, the result is normalized relative to the reference cell position for the calibration sample η_{iεc} as the detector efficiency calibration incorporates system attenuation effects (e.g. filters).

ηᵣ_{²}ᵢ is the r² geometric correction in cell i, normalized to the reference cell. The r² geometric correction is calculated as the square of the distance Rᵢ from cell i to the centroid of the detector:

$${η}_{{r}^{2}} = \frac{{R}_{i}^{2}}{{R}^{2}}$$

Where R is the distance from the reference cell to the detector.

The spectrum is corrected by multiplication of the combined correction factor fₑ with the number of counts at the energy of interest (i.e. the peak area). The corrected spectrum is comprised of a list of corrected peak areas (in photon counts), A′ₑ, for a corresponding energy e, each calculated by:

A′ₑ=fₑAₑ

The mass composition estimate for the element ε associated with a peak of interest is M_{ε}=A′ₑK_{εe}.

K_{εe} is the conversion factor, in grams per count, for the specific gamma-ray peak of interest, of the element ε, for a grain of the element (ie. with negligible geometric effects, gamma self-absorption or thermal neutron self-absorption) at the center of the reference cell, exposed to the thermal equivalent neutron flux calculated for the reference cell and reference sample.

$${K}_{ɛ ɛ} = \frac{A}{{N}_{A} {Φ}_{tr} {ɛ}_{e} {σ}_{ɛ e} t}$$

### Where:

A is the atomic mass, in grams per mole.
N_{A} is Avagadro's number, 6.022×10²³ atoms/mole.
Φ_{τr} is the thermal equivalent neutron flux calculated for the reference cell and reference sample, in n·cm⁻²·s⁻¹.

εₑ is the detector efficiency for gamma rays generated in the reference cell, at a gamma-ray energy ε corresponding to a peak of interest. The detector efficiency may be determined by calibration tests or modeling of pure samples of the element within the system such that all system effects on detector efficiency are accounted for.

σ_{εe} is the gamma production cross-section for the thermal-neutron-gamma reaction of gamma-ray energy e produced by element ε corresponding to a peak of interest, in cm⁻²·n. Such data is available for example in “Handbook of Prompt Gamma Activation Analysis”, G. Molnar, Chapter 7.

t is the integration time, in seconds.

In the exemplary case, a 3-dimensional grid of 0.5 mm spatial resolution was used, resulting in a matrix of 94×94×200 cells for a 47 mm diameter cylindrical sample of length 100 mm.

It will be apparent to one with skill in the art that the elemental analyzer system of the invention may be provided using some or all of the mentioned features and components without departing from the spirit and scope of the present invention. It will also be apparent to the skilled artisan that the embodiments described above are specific examples of a single broader invention that may have greater scope than any of the singular descriptions taught.

What is claimed is:

1. A system for elemental analysis comprising:
one or more neutron emitters;
a chamber for containing a test sample;
at least one gamma ray detector electrically connected to a data acquisition system; and
software or firmware executing on the data acquisition system from a non-transitory physical medium, the software or firmware providing:
a first function for producing one or more gamma ray spectrums;
a second function for applying correction factors to the one or more gamma ray spectrums; and
a third function for analyzing the corrected gamma ray spectrum or spectrums to determine a deconvolved elemental composition of the test sample.

2. The system of claim 1, wherein the correction factors include one or a combination of a gamma ray self-shielding factor, a thermal neutron self-absorption factor, and a geometric correction factor.

3. The system of claim 1, further comprising:
at least one moderator material for moderating emitted neutrons to thermal energy.

4. The system of claim 1, further comprising a removable seed strategically positioned relative to the at least one gamma ray detector, the seed generating gamma rays, the gamma rays passing through the test sample.

5. The system of claim 4, wherein the removable seed is made of mercury.

6. The system of claim 4, wherein gamma-ray attenuation through the test sample is measured to compute a gamma-ray self-shielding correction factor.

7. The system of claim 4, wherein the removable seed emits multiple Prompt Gamma Neutron Activation Analysis (PGNAA) peaks across a wide energy range exhibiting minimal overlap with PGNAA peaks emitted from the test sample in process.

8. The system of claim 4, wherein the removable seed comprises more than one element.

9. The system of claim 1, further comprising:
a removable thermal neutron shield strategically positioned about the test sample, the shield surrounding a removable seed strategically positioned opposite the shield opening.

10. The system of claim 9, wherein neutron attenuation through the sample is measured to compute a thermal neutron self-absorption correction factor

11. The system of claim 9, wherein the removable seed is formed of cadmium, mercury, samarium, gadolinium, or a combination thereof.

12. The system of claim 1, wherein there are two gamma ray spectrums produced, one a PGNAA spectrum and the other a Delayed Gamma Neutron Analysis (DGNA) spectrum, and wherein both spectrums are analyzed by the third software function.

13. The system of claim 12, wherein a second gamma ray detector measures the DGNA gamma ray spectrum after repositioning the test sample.

14. In a system for elemental analysis, the system including one or more neutron emitters, a chamber for containing a test sample, and at least one gamma ray detector electrically connected to a data acquisition system, a method for correcting a gamma ray spectrum to determine a deconvolved elemental composition comprising the steps:
(a) using software or firmware executing on the data acquisition system, determining the sample geometry and computing a geometric correction factor, the factor accounting for varying distances between nuclei in the test sample and the gamma-ray detector;
(b) using the software or firmware of step (a), measuring a gamma ray spectrum, providing a first elemental composition for the sample;
(c) using nuclear modeling software or firmware executing on the data acquisition system, computing the rate of neutron and gamma ray absorption through a sample of the first elemental composition and sample geometry;
(d) using the software or firmware of step (a), computing gamma-ray self-shielding and thermal neutron self absorption correction factors;
(e) using the software or firmware of step (a), correcting the gamma-ray spectrum of step (b) according to results of steps (a), (c), and (d);
(f) using the software or firmware of step (a), analyzing the corrected gamma-ray spectrum to obtain a second elemental composition;
(g) using the software or firmware of step (a), calculating the difference between the second elemental composition of step (f), and the first elemental composition of step (b), comparing the difference to an established threshold value; and
(h) assuming the difference calculated in step (g) is below the established threshold value, adopting the second elemental composition as the final deconvolved elemental composition.

15. The method of claim 14, wherein in step (b), the first elemental composition is substantially pure silica.

16. The method of claim 15, wherein in step (f), the second elemental composition is derived by analyzing the gamma-ray peaks present in the corrected gamma-ray spectrum and comparing the gamma-ray peak intensities to a library containing the theoretical peaks for all pure elements, with the balance of mass assumed to be pure Silica.

17. The method of claim 14, wherein the gamma ray spectrum is a PGNAA gamma ray spectrum, or a DGNA gamma ray spectrum.

18. The method of claim 17, wherein the system for elemental analysis produces a DGNA gamma ray spectrum and further includes a removable seed formed of Dysprosium, Europium, Indium, Lutetium, Manganese, or any combination thereof.

19. The method of claim 14, wherein the data acquisition system is electrically connected to the gamma ray detector.

20. The method of claim 14, wherein in step (h), if the difference is larger than the established threshold, steps (c) through (g) are repeated replacing the first elemental composition of step (b) with the second elemental composition of step (f).

21. The method of claim 14, wherein in step (b), the first elemental composition is other than silica.
